(19) United States
(12) Patent Application Publication
(10) Pub. No.: US 2010/0057350 A1
(43) Pub. Date: Mar. 4, 2010

(54) Method and system for automatically and directly establishing contact between a driver and at least one person to be transported

(76) Inventors: Adrien Joly, Nozay (FR); Fabien Bataille, Nozay (FR)

Correspondence Address: Carmen Patti Law Group, LLC, One N. LaSalle Street, 44th Floor, Chicago, IL, 60602, US

(21) Appl. No.: 12/583,995

(22) Filed: Aug. 28, 2009

(30) Foreign Application Priority Data
Aug. 29, 2008 (FR) 0855791

(51) Int. Cl. G01C 21/00

(52) U.S. Cl. 701/207

(57) ABSTRACT

A system is devoted to automatically establishing contact between an automobile vehicle's (V) driver (D) and at least one person (P) who wishes to be transported. This system comprises i) analysis means (ANM) tasked with determining, firstly, whether at least one driver (D) is disposed to transport at least one person (P) over at least part of a first usual known route in progress, based on background information pertaining to said driver, and secondly, if at least one person (P) wishes to be transported over at least part of a second usual known route in progress based on background information pertaining to said person, ii) calculation means (CLM) tasked with determining a first route in progress which includes a significant part of a second route in progress, and iii) communication means (CNM) tasked with establishing contact between the corresponding driver (D) and person (P) respectively taking said first and second routes determined by said calculation means (CLM), via first (T1) and second (T2) communication devices, which they carry respectively.

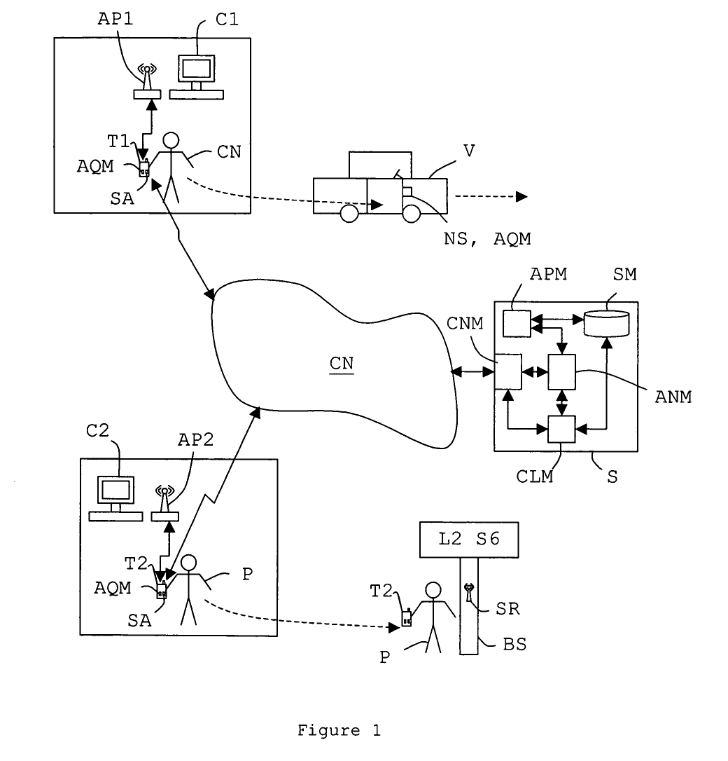

The invention pertains to establishing contact between the driver of an automobile vehicle and at least one person who wishes to be transported.

Here, the term “driver” refers both to a person who uses his or her automobile vehicle for private purposes and to a taxi driver. Consequently, establishing contact may occur either as part of car-sharing or as part of a taxi drive, in order to make a shared trip (which may potentially be cooperative and/or potentially charged).

As is known to a person skilled in the art, numerous solutions have already been proposed for carpooling. However, none of them are fully satisfactory.

This is because most of them lack flexibility because they require preregistration in advance, and not in real time. The drivers must not only report the route that they wish to take in advance, but also their departure times and when they will pass by selected intermediate locations where they offer to pick up at least one person, and therefore the people to be transported are restricted by the pick-up times set in advance by the drivers. This is, for example, the situation with the solutions known as “123 en voiture”, “la roue verte”, and “écovoiturage” implemented in France.

Naturally, there are more flexible solutions, even dynamic (or real-time) ones, but they are not fully satisfactory, such as because they are difficult to apply to large geographical areas and/or because they require specific travel lanes and/or because they always require that the user take preliminary action, on his or her own initiative, such as by generating a message (an SMS or similar message) to signal that a person can be picked up and that someone wants to be picked up and the route that will be taken. This is, for example the situation with the solution known as “Ecolane Dynamic Carpool” implemented in the region of Helsinki, Finland; the solution known as “eNotions” offered by the airport of Frankfurt, Germany; the solution offered by Nokia in the article “Empty Seats Traveling”, or the solution known as “Taxi on Demand” (or ToD) developed as part of the “LIAISON Integrated Project”.

The purpose of the invention is therefore to improve the situation by offering a solution that is dynamic, flexible, and simple-to-use for both drivers and people to be transported.

To that end, it proposes a method, intended to automatically establish contact between an automobile vehicle's driver and at least one person who wishes to be transported, and consisting of:
i) determining whether at least one driver is disposed to transport at least one person over at least part of a first usual known route in progress, based on background information pertaining to said driver,
ii) determining whether at least one person wishes to be transported over at least part of a second usual known route in progress based on background information pertaining to said person, and
iii) determining a first route in progress which includes a significant part of a second route in progress in order to establish contact between the corresponding driver and person via first and second communication devices, which they carry respectively.

The method of the invention may comprise other characteristics, which may be taken separately or in combination, in particular:
in i) it may be determined whether a driver has begun a first known route that he or she usually takes based on background information pertaining to him or her, and if so, that driver may be asked, via his or her first communication device, whether he or she is disposed to transport at least one person over at least part of the first determined route in progress;
in i) background information may be used, selected from (at least) a change in a first communication device's access network, a current time, presence detection within the automobile vehicle, detecting that a location having a known geographic position is being passed, a current determined geographic position of the automobile vehicle, and data from a source of appointment data;
in ii) it may be determined whether a person has begun a second known route that he or she ordinarily takes based on background information pertaining to him or her, and if so, that person may be asked, via his or her second communication device, whether he or she wishes to be transported over at least part of the second determined route in progress;
in ii) background information may be used, selected from (at least) a change in a second communication device's access network, a current time, presence detection or a known geographic position being passed, a determined geographic position, and data from a source of appointment data;
   a person's presence may be detected by means of at least one technique chosen from (at least) the acquisition of an identifier associated with a known geographic position, geographic positioning by means of a satellite navigation device, geographic positioning by triangulation within a wireless communication network, and geographic positioning by identifying an access point on a wireless communication network to which a second communication device is connected;
the background information may be assigned selected weight based on the levels of confidence respectively accorded to each piece of information, and each first or second route in progress may be determined based on this background information and associated respective weighting;
for each driver and each person, it may include a phase of learning each of their usual first and second routes. It should be noted that this phase of learning is preferentially ongoing.

The invention also discloses a system intended to automatically establish contact (as part of the service) between an automobile vehicle's driver and at least one person who wishes to be transported, and comprising:
analysis means tasked with determining both whether a driver is disposed to transport at least one person over at least part of a first usual known route in progress, based on background information pertaining to him or her, and also whether a person wishes to be transported over at least part of a second usual known route in progress, based on background information pertaining to him or her,
calculation means tasked with determining a first route in progress which includes a significant part of a second route in progress, and
communication means tasked with establishing contact between the driver and the person who respectively take the first and second routes determined by the calculation means, via first and second communication devices which they respectively carry.

The inventive system may comprise other characteristics, which may be taken separately or in combination, in particular:
its analysis means may be tasked with determining whether a driver has begun a first known route that he or she ordinarily takes based on background information pertaining to him or her, and if so, that driver may be asked, via his or her first communication device, whether he or she is disposed to transport at least one person over at least part of the first determined route in progress;
it may comprise acquisition means tasked with acquiring the background information pertaining to a driver from among (at least) a change in a first communication device's access network, a current time, a usual time when the first route begins, presence detection within the automobile vehicle, detecting that a location having a known geographic position is being passed, a current determined geographic position of the automobile vehicle, and data from a source of appointment data;
its analysis means may be tasked with determining whether a person has begun a second known route that he or she usually takes based on background information pertaining to him or her, and if so, that person may be asked, via his or her second communication device, whether he or she wishes to be transported over at least part of the second determined route in progress;
it may comprise acquisition means tasked with acquiring the background information pertaining to a person from among (at least) a change in a second communication device's access network, a current time, a usual time when a second route begins, presence detection or a determined geographic position being passed, a determined geographic position, and data from a source of appointment data;
   a person's presence may be detected by means of at least one technique chosen from (at least) the acquisition of an identifier associated with a known geographic position, geographic positioning by means of a satellite navigation device, geographic positioning by triangulation within a wireless communication network, and geographic positioning by identifying an access point on a wireless communication network to which a second communication device is connected;
its analysis means may be tasked with determining each first or second route in progress based on background information and the weighting assigned to that information based on the levels of confidence which are respectively accorded to them;
it may comprise learning means tasked with acquiring said first and/or second usual route(s) of at least one driver and at least one person;
it may comprise a server connected to at least one communication network and comprising calculation means and at least one part of the analysis means and/or at least one part of the learning means.

Other characteristics and advantages of the invention will become apparent upon examining the detailed description below, and the attached drawings, in which the sole FIGURE schematically depicts an example embodiment of an inventive system for establishing contact, coupled with a communication network, and in the presence of both an automobile vehicle driver who may transport at least one person and an person who may be transported.

The drawing may serve not only to complete the invention, but also to contribute to defining it, if need be.

The object of the invention is to enable the automatic and dynamic establishment of contact (i.e. in real time) of an automobile vehicle driver and at least one person who wishes to be transported.

As is depicted in the sole FIGURE, the implementation of the invention (both in the form of a method and in the form of a system) requires firstly that each driver D of an automobile vehicle V who may transport at least one person (potentially through carpooling) be equipped with a first portable (or mobile or cellular) communication device T1, and secondly that each person P who may be transported (potentially through carpooling) be equipped with a second portable (or mobile or cellular) communication device T2.

In what follows, it is assumed by way of a nonlimiting example that the first T1 and second T2 portable communication devices are mobile (or cellular) telephones. However, the invention is not limited to this type of portable communication device. In reality, it pertains to any type of portable communication device that may establish two-way communication with other portable or stationary communication devices. Consequently, it may also be a portable computer or a personal digital assistant (or PDA) or a communicating satellite guiding system, for example.

The invention proposes implementing a method for establishing contact, comprising at least three main steps. It is important to note that such a method may be implemented by means of a system for establishing contact of the type that is schematically and functionally depicted in the sole FIGURE.

Such a system comprises at least analysis means ANM, calculation means CLM, and communication means CNM, and preferentially acquisition means AQM and learning means LEM as well. In the non-limiting example depicted in the sole FIGURE, the analysis means ANM, the calculation means CLM, the communication means CNM, and the learning means LEM are installed in a server S connected to (or accessible from) a communication network CN, while the acquisition means AQM are installed in the first T1 and second T2 mobile telephones. However, this is not mandatory. Rather, it may be conceived that instead of being centralized in one or more servers, at least some of the analysis means ANM, at least some of the calculation means CLM, at least some of the learning means LEM, and the acquisition means AQM may be installed in a distributed fashion within the first T1 and second T2 mobile telephones and in the automobile vehicle V.

The first main step (i) of the inventive method consists of determining whether at least one driver D is disposed to transport, with his or her automobile vehicle V, at least one person over at least part of the known first route that he or she usually takes and that he or she has just begun (in progress), based on background information pertaining to said driver.

Here, it shall be understood that at a given moment, all the drivers D who subscribe to the contact establishment service who have just begun a route are determined, then for each driver D thereby determined, based on background information pertaining to him or her, it is determined whether that route is a route which he or she usually takes (and which is here known as the “first route”).

This first step (i) may, for example, be done in two successive substeps. In a first substep, it may be determined, for example, whether a driver D began a first known route (which he or she usually takes), based on background information pertaining to him or her.

This first substep may be implemented by the system's analysis means ANM, here installed on the server S.

If a driver D was determined during the first substep, a second substep is then performed, which may, for example, consist of asking that driver, via his or her mobile telephone, whether he or she is disposed to transport at least one person over at least part of the first determined route in progress.

This second substep may also be implemented by the system's analysis means ANM, here installed on the server S. More precisely, the analysis means ANM order the system's communication means CNM to send the first mobile telephone T1 of the driver D that they have just determined during the first substep a message asking him or her whether he or she will agree to transport at least one person over at least part of the first determined route that he or she just began. For example, each first mobile telephone (or more generally, first portable communication device) T1 comprises (as depicted) a software application SA devoted to the contact establishment service and tasked with processing the received message. It should be noted that such a software application is not a necessity. Other interface means may be considered.

In reality, the message's first goal may be to ask the driver D to confirm that he or she has indeed just begun the first determined route (for example, between his or her house and his or her office). In this situation, the software application SA may, for example cause the driver D's first mobile telephone T1 to display on-screen the known list of his or her first usual routes, by placing at the start of the list the one which was determined by the system's analysis means ANM. The driver D may then select either the first determined route placed at the start of the list if he or she is actually taking it, or another first route from the list if the system's analysis means were incorrect (prediction error). Next, the software application SA may, for example, cause the driver D's first mobile telephone T1 to display on-screen a message such as “Do you wish to carpool over the selected first route?” or “Do you wish to make a pickup on the selected first route?”, with “Yes” and “No” as possible answers. If the driver D refuses to carpool, or more generally, to make a pickup (selecting the No option), the method stops there for that driver D. On the other hand, if the driver D agrees to carpool, or more generally to make a pickup (selecting the Yes option), the method moves onto the third main step.

The background information pertaining to the drivers D may be of any sort, provided that it gives indications that make it possible to determine, and more precisely to predict, which first route a driver D is taking at a given moment (in progress). Thus, and in a nonexhaustive and therefore nonlimiting fashion, it may be a change in that driver D's first mobile telephone T1's access network, the current time, detecting the presence of that driver D within his or her automobile vehicle V, detecting that the driver D has passed by a location having a known geographic position (such as, for example, the entrance to/exit from his or her company through a badge-reading system), the determined current geographic position of that driver D's automobile vehicle V, and information (related to an appointment) stored in an electronic calendar (or more generally, an appointment and/or schedule database).

This background information is determined by the acquisition means AQM which are installed in at least the driver D's first mobile telephone T1, but which could also and/or additionally be installed in the driver D's other communicating devices, such as, for example, his or desktop computer C1 and/or his or her automobile vehicle V.

Any sort of acquisition means AQM that can be used to acquire background information may be used. Thus, and in a nonexhaustive and therefore nonlimiting fashion, it may be:
a clock of a first mobile telephone T1 providing the current time,
a detection means coupled to the communication module of the first mobile telephone T1 in such a way as to detect the changes in how it connects to radio access networks. For example, it may be detected that the first mobile telephone T1 has just disconnected from the WiFi or Bluetooth access point AP1 (which is installed in the driver D's home and which is connected to a communication network via said driver D's desktop computer C1), which indicates that the driver has just left his or her home with his or her mobile telephone T1, then detecting that the first mobile telephone T1 has just connected to the WiFi or Bluetooth access point or to a communicating satellite navigation system NS (which is installed in the driver automobile vehicle V and which is connected to a radio communication network), which indicates that the driver Dl has just gotten into the driver's seat of his or her automobile vehicle V, and potentially turned on that system NS,
a presence detection means, such as a satellite navigation system NS installed in the driver D's automobile vehicle V and which, when activated, indicates that the driver D has just gotten into the driver's seat of his or her automobile vehicle V, or a microphone and sound spectrum analyzer installed in the automobile vehicle V, or in the driver D's first mobile telephone T1 and which, when activated, are together capable of capturing sounds and determining whether the automobile vehicle V's engine has been turned on, or a miniature camera installed in the driver's seat of the driver D's automobile vehicle V and observing the space devoted to the driver, and which, when activated, indicates that the driver D has gotten into the driver's seat of his or her automobile vehicle V,
a means for detecting that a driver D has passed by a location having a known geographic position (for example, an electronic passageway or gate entering or leaving a company),
a positioning means, such as using a satellite navigation system NS installed in the driver D's automobile vehicle V and which, when activated, is capable of determining the current geographic position of the automobile vehicle V. This activation may, for example, be done automatically when the driver turns on the engine of his or her automobile vehicle using his or her keys or an electronic box (or card). It shall be noted that it is even possible to conceive of the driver being identified whenever each driver of an automobile vehicle uses a personally identified key. In this situation, the system NS may potentially directly transmit each location to the system once it has been activated. In variants, the location may be given by the infrastructure of the communication network provider, using surveillance cameras installed in known geographic positions, or by detectors of emitting beams (installed in the automobile vehicles and potentially RFID or NFC detectors), which may, for example, be located on the roadsides (potentially in the kilometer markers). In this situation, the detector sends each beam identifier that it has identified to the system, the driver D's location then being determined by matching up the detector's identifier and the detector's known geographic position.

It should be noted that one or more background information acquisition techniques may be implemented.

It should be understood that depending upon their type, the acquisition means AQM may communicate the background information that they acquire either to the driver D's first mobile telephone T1, which will then communicate them to the analysis means ANM which are local or installed in the server S as in the example depicted (in this situation, the communication is by radio via the radio communication network CN to which the first mobile telephone T1 is connected), or to the server S by means of a radio communication module (specific to or installed in the automobile vehicle V) connected to a radio communication network.

Wherever they are installed, the analysis means ANM are tasked with determining (or predicting) a driver D's route in progress based firstly on background information pertaining to him or her which has just been acquired by the various acquisition means AQM associated with a driver D, and definition(s) of that driver D's first known usual route(s).

The digital data defining each of a driver D's first known usual routes are stored, matched with an identifier of that driver D, in storage means SM which are installed in the server S, as in the example depicted, or the first mobile telephone T1 of the driver D. This digital data may, for example, represent the normal starting time of a first route, the geographic positions of the starting and destination locations of a first route, and preferentially the geographic positions of intermediate locations that a first route passes by, and potentially the usual arrival time at the final destination of a first route and the usual times when it passes by the intermediate locations.

It should be noted that multiple known usual first routes may be associated with a single driver D. Furthermore, an alphanumeric identifier may be associated with a driver D's known first route. For example, this alphanumeric identifier may be a word such as “office”, “factory”, “parents”, “Bruno”, “Adrien”, “airport X”, “train station Y”, or “sporting complex Z”. It should be noted that this identifier may be automatically assigned by the system (analysis means ANM), for example based on the destination and/or a repetitive or routine nature, or by the driver D.

Each first route definition may, for example, be generated by learning means LEM which are installed on the server S, such as in the example detected, or in the driver D's first mobile telephone T1.

The first route is preferentially learned over several days in order to have sufficient statistics both in terms of (at least) departure times and (at least) departure and destination locations. It should be understood that this learning conventionally consists of saving data about a driver D's routes, then attempting to establish correlations between that data.

For example, if the learning means LEM notice that three days in a row, a driver D leaves at roughly the same starting time X from the same starting location Y (for example, his or her home) and always arrives at the same destination location Z (for example, his or her office), then they can generate for that driver D a first route defined at least by that starting time X, that starting location Y and that destination location Z (potentially completed by intermediate locations and times that are always passed, and by an average arrival time).

However, in one variant, a driver D may manually define at least one of his or her first usual route(s) with the software application and the human/machine interface of his or her first mobile telephone T1 or satellite navigation system NS used to locate him or her.

It is important to note that the learning phase is preferentially ongoing, so as to enable potential updates to the first routes of a driver D and/or to define new first routes.

It should be understood that when the analysis means ANM understand that a driver D has just begun a route with his or her automobile vehicle V using some background information received pertaining to him or her (such as, for example, his or her presence in his or her automobile vehicle V and/or a change in the radio access network of his or her first mobile telephone T1), they compare some other background information received pertaining to that driver D (such as, for example, the current time and day, and his or her current geographic position) with the data defining that driver D's known usual first routes. If there is a match between the background information received and the data defining a known usual first route, the analysis means ANM deduce therefrom that the driver D has begun that known usual first route.

It should be noted that selected weighting may potentially be assigned to the various types of background information depending on the levels of confidence that are respectively granted to them. Indeed, it should be understood that the level of confidence that is granted to the detection of an engine's noise must be less than the one which is granted to the detection of a driver D's presence in his or her automobile vehicle V by a miniature camera or the use of the automobile vehicle V's satellite navigation system.

When such weighting is assigned to the various types of background information, the analysis means ANM determine each first route in progress based on background information and their respective associated weighting. It should be noted that the weighting which is assigned to certain types of background information may vary based on the context. This is because one type of background information may, for example, have a first weight during the activation phase (departure from home and/or entry into the automobile vehicle and turning on the engine), and a second weight during the positioning phase (while the automobile vehicle is traveling).

The main second step (ii) of the inventive method consists of determining whether at least one person P wishes be transported over at least part of a second known route, which he or she usually takes and which he or she has just begun (in progress), based on background information pertaining to him or her.

It should be noted that this second step (ii) has similarities with the first step and is generally performed at roughly the same time. What distinguishes this first step is essentially the fact that it pertains to a person P who does not use his or her (or does not have an) automobile vehicle, and therefore the acquisition means AQM which are used are at least partially different.

Here, it shall be understood that at a given moment, all the people P who subscribe to the contact establishment service who have just begun a route are determined, then for each person P thereby determined, based on background information pertaining to him or her, it is determined whether that route is a route which he or she usually takes (and which is here known as the “second route”).

It is important to note that a person P may potentially be a driver D at certain times. Consequently, a second route may potentially be identical or at least partially identical to a first route. For example, a second route may be distinguished from a first route by a different starting time (generally later).

This second step (i) may, for example, be done in two successive substeps. In a first substep, it may, for example, be determined whether a person P has begun a second known route (which he or she usually takes) based on background information pertaining to him or her.

This first substep may be implemented by the system's analysis means ANM, here installed on the server S (by way of example).

It should be noted that it is more difficult to determine (predict) a second route once a person P has left his or her starting location. This determination may, for example, initially be made based on the starting time and the starting location.

If a person P has been determined during the first subset, then a second substep is performed consisting, for example, of asking that person P, via his or her second mobile telephone T2, if he or she wants to be transported over at least part of the second determined route in progress.

This second substep may also be implemented by the system's analysis means ANM, here installed on the server S. More precisely, the analysis means ANM order the system's communication means CNM to send the second mobile telephone T2 of the person D that they have just determined during the first substep a message asking him or her whether he or she wishes to be transported over at least part of the second determined route that he or she just began. For example, each second mobile telephone T2 comprises (as depicted) a software application SA devoted to the contact establishment service and tasked with processing the received message. It should be noted that such a software application is not a necessity. Other interface means may be considered.

In reality, the message's first goal may be to ask the person P to confirm that he or she has indeed just begun the second determined route (for example, between his or her house and his or her office). In this situation, the software application SA may for example cause the person P's second mobile telephone T2 to display on-screen the known list of his or her second usual routes, by placing at the start of the list the one which was determined by the system's analysis means ANM. The person P may then select either the second determined route placed at the start of the list if he or she is actually taking it, or a second route from the list if the system's analysis means ANM were incorrect (prediction error). Next, the software application SA may, for example, cause the person P's second mobile telephone T2 to display on-screen a message such as “Do you want to be transported over the second selected route?” or “Do you want to be picked up on the second selected route?”, with “Yes” and “No” as possible answers. If the person P refuses to carpool, or more generally, to be picked up (selecting the No option), the method stops there for that person P. On the other hand, if the person P agrees to carpool, or more generally to be picked up (selecting the Yes option), the method moves onto the third main step.

The background information pertaining to the people P may be of any sort provided that it gives indications that make it possible to determine, and more precisely to predict, which second route a person P is taking. Thus, and in a nonexhaustive and therefore nonlimiting fashion, it may be a change in that person P's second mobile telephone T2's access network, the current time, detecting the presence of that person P in the vicinity of a known (identifiable) location, such as a subway station or bus stop BS, detecting that the person P has passed by a location having a known geographic position (such as, for example, the entrance to/exit from his or her company through a badge-reading system), that person P's determined current geographic position, and information (related to an appointment) stored in an electronic calendar (or more generally, an appointment and/or schedule database).

This background information is determined by acquisition means AQM which are installed at least in the person P's second mobile telephone T2, but which may also and/or additionally be installed in that person P's other communicating devices, such as, for example, his or desktop computer C2, or in communicating devices installed in known locations, such as in subway stations or bus stops BS.

Any sort of acquisition means AQM that can be used to acquire background information may be used. Thus, and in a nonexhaustive and therefore nonlimiting fashion, it may be:
a clock of a second mobile telephone T2 providing the current time,
a detection means coupled to the communication module of the second mobile telephone T2 in such a way as to detect changes in how it connects to radio access networks. For example, it may be detected that the second mobile telephone T2 has just disconnected from the WiFi or Bluetooth access point AP2 (which is installed in the person P's home and which is connected to a communication network via said driver D's desktop computer C2), which indicates that the driver has just left his or her home with his or her mobile telephone T2, then detecting that the second mobile telephone T2 has just connected to a WiFi or Bluetooth access point or a base station, which indicates that that person is located in the vicinity of a location whose geographic position is known,
a means for detecting that a person P is at a location having a known geographic position (for example, an electronic passageway or gate entering or leaving a company),
a presence detection means, such as an acquisition means making it possible to acquire an identifier which is associated with a known and geographic location. The acquisition of that identifier may be done manually by entering into the human/machine interface of a second mobile telephone T2 or by photographing using a camera equipping a second mobile telephone T2. In such a situation, the identifier is displayed on a medium in front of which the person P is positioned. However, the identifier may also be acquired automatically by remotely receiving (or collecting) a code stored in a sender/receiver SR, such as an RFID (“Radio Frequency Identifier”), installed in a known location, such as a subway station or a bus stop BS (as depicted, in a nonlimiting fashion),
a positioning means, such as a satellite navigation system NS or a wireless communication network triangulation system installed in the person P's second mobile telephone T2 that is capable of determining that person P's current geographic position.

It should be noted that one or more background information acquisition techniques may be implemented.

It should be understood that depending upon their type, the acquisition means AQM may communicate the background information that they acquire either to the person P's second mobile telephone T2, which will then communicate them to the analysis means ANM which are local or installed in the server S as in the example depicted (in this situation, the communication is by radio via the radio communication network CN to which the second mobile telephone T2 is connected), or to the server S by means of a radio communication module (specific to or installed in the automobile vehicle V) connected to a radio communication network.

Wherever they are installed, the analysis means ANM are tasked with determining (or predicting) a person P's route in progress based on background information pertaining to him or her which has just been acquired by the various acquisition means AQM associated with a person P, and definition(s) of that person P's second known usual route(s).

The digital data defining each of a person P's second known usual routes are stored, matched with an identifier of that person P, in storage means SM which are installed in the server S, as in the example depicted, or the second mobile telephone T2 of the person P. This digital data may, for example, represent the normal starting time of a second route, the geographic position of the destination locations of a second route, and preferentially the geographic position of the starting location of a second route and/or the geographic positions of intermediate locations that a second route passes by, and potentially the usual arrival time at the final destination of a second route and the usual times when it passes by the intermediate locations.

It should be noted that several known usual second routes may be associated with a single person P. Furthermore, an alphanumeric identifier may be associated with each known second route of a person P. For example, this alphanumeric identifier may be a word such as “office”, “factory”, “parents”, “Bruno”, “Adrien”, “airport X”, “train station Y”, or “sporting complex Z”. It should be noted that this identifier may be automatically assigned by the system (analysis means ANM), for example based on the destination and/or a repetitive or routine nature, or by the person P.

Each first route definition may, for example, be generated by learning means LEM which are installed on the server S, such as in the example detected, or in the person P's second mobile telephone T2.

As previously indicated, the second route is preferentially learned over several days in order to have sufficient statistics both in terms of (at least) starting times and (at least) starting and destination locations. This learning conventionally consists of saving data about a person P's routes, then attempting to establish correlations between that data.

For example, if the learning means LEM notice that three days in a row, a person P leaves at roughly the same starting time X from the same starting location Y (for example, his or her home) and always arrives at the same destination location Z (for example, his or her office), then they can generate for that person P a second route defined at least by that starting time X, that starting location Y and that destination location Z (potentially completed by intermediate locations and times that are always passed, and by an average arrival time).

However, in one variant, it may be assumed that a person P manually defines at least one of his or her second usual route(s) with the software application SA and the human/machine interface of his or her second mobile telephone T2.

It is important to note that the learning phase is preferentially ongoing, so as to enable potential updates to the second routes of a person P and/or to define new second routes.

It should be understood that when the analysis means ANM understand that a person P has just begun a route using some background information received pertaining to him or her (such as, for example, his or her presence in his or her automobile vehicle V and/or changing the radio access network of his or her second mobile telephone T2), they compare some other background information received pertaining to that person P (such as, for example, the current time and day, and his or her current geographic position) with the data defining that person P's known usual second routes. If there is a match between the background information received and the data defining a known usual second route, the analysis means ANM deduce therefrom that the person P has begun that known usual second route. In the event of (excessive) major ambiguities, the person P may be offered a list of possible destinations (potentially from among his or her most recent ones) so that he or she can make a selection.

As previously indicated, selected weighting may be assigned to various types of background information regarding the people P based on the levels of confidence respectively accorded to them. When such weighting is assigned to the various types of background information, the analysis means ANM determine each second route in progress based on background information and their respective associated weighting. It should be noted that the weighting which is assigned to certain types of background information may vary based on the context.

The third main step (iii) of the inventive method consists of determining whether there is a first route in progress (determined during a first step (i)) which includes a significant part of a second route in progress (determined during a second step (ii)), in order to establish contact between the corresponding driver D and person P via their respective first T1 and second T2 mobile telephones. It should be noted that a significant part of a second route in progress may be the largest possible part of that second route in progress. However, this is not mandatory. Rather, it may be conceived that it is preferable to drop off a person P at an intermediate location (a transfer) on his or her second route in progress, for example a train station, a subway station, a bus or taxi stop, or more generally a selected location, because this will enable that person P more directly and/or more easily reach his or her destination, potentially via at least one other pick-up (carpooling or taxi).

This third step (iii) may be implemented by the system's calculation means CLM, which here are centralized because they are installed in the server S.

Any reconciliation technique known to the person skilled in the art, which makes it possible to determine from among the known first routes which one has a significant correlation with (or potentially which best corresponds to) a second known route, may be used here. The invention does not deal with this reconciliation technique. It will simply be noted that the reconciliation technique may potentially use information stored in databases, which may, for example, be expected train, tram, bus, subway, airplane, or boat departure and arrival times, and potentially predicted times when they will pass by predefined intermediate locations (stations, stops) and/or expected delays and/or detour or alternative routes and/or construction-period routes and/or problems on sections of roads.

If the calculation means CLM determine from among the various first routes in progress (for which the corresponding drivers D have agreed to carpool, or more generally, make pickups) a first route in progress which includes a significant portion (potentially the largest portion, or even all) of a second route in progress (for which the corresponding people P have reported their desire to carpool, or more generally to be picked up) and which will make it possible to provide a meeting place compatible with the times when the driver D and person P in question will pass by, they order the system's communication means CMN to address first and second messages, respectively, to the first T1 and second T2 mobile telephones respectively, of the driver D and person P in question.

The purpose of the first message is to indicate the driver D the place where he or she may pick up the person P, as well as the pick-up time (appointment), a brief description of that person P (previously saved and/or provided or completed by entry) and the name of that person P (previously saved and/or provided by entry).

The purpose of the second message is to indicate to the person P the place where he or she may be picked up, as well as the pick-up time (appointment) and a brief description of the automobile vehicle V (previously saved and/or provided by entry), and potentially a brief description of the driver D (previously saved and/or provided or completed by entry) and/or the name of that driver D (previously saved and/or provided by entry).

In the example depicted, the place where the person P is picked up by the driver D is bus stop BS #6 (S6) on the #2 line (L2), where that person P, in the example, has been located by the identifier of a sender/receiver SR and where he or she will, in the example, need to wait for five minutes for the driver D's automobile vehicle V to arrive (whereas he or she may have had to wait 12 minutes for the bus to arrive on the #2 line (L2)).

It should be noted that the analysis means ANM, the calculation means CLM, certain acquisition means AQM and the learning means LEM may be constructed in the form of software (or computer) modules. However, they may also be constructed in the form of electronic circuits or a combination of electronic circuits and software modules.

The invention is not limited to the embodiments of the method, system, and server described above, which are only given by way of example; rather, it encompasses all variants that a person skilled in the art may envision within the framework of the claims below.

1. A method for automatically establishing contact between an automobile vehicle's (V) driver (D) and at least one person (P) who wishes to be transported, characterized in that consists of i) determining whether at least one driver (D) is disposed to transport at least one person (P) over at least part of a first usual known route in progress, based on background information pertaining to said driver, ii) determining whether at least one person (P) wishes to be transported over at least part of a second usual known route in progress based on background information pertaining to said person, and iii) determining a first route in progress which includes a significant part of a second route in progress in order to establish contact between the corresponding driver (D) and person (P) via first (T1) and second (T2) communication devices, which they carry respectively.

2. A method according to claim 1, characterized in that during step i) it is determined whether a driver (D) has begun a first known route which he or she usually takes, based on background information pertaining to him or her, and if so, asking that driver (D), via his or her first communication device (T1), whether he or she is disposed to transport at least one person (P) over at least part of said first determined route in progress.

3. A method according to claim 1, characterized in that during step i) background information is used, selected from (at least) a change in the network used for access by a first communication device (T1), a current time, presence detection in the automobile vehicle (V), detecting that a location having a known geographic position is being passed, the automobile vehicle's (V) current determined geographic position, and data from a source of appointment data.

4. A method according to claim 1, characterized in that in during step ii) it is determined whether a person (P) has begun a second known route that he or she usually takes based on background information pertaining to him or her, and if so, asking that person (P), via his or her second communication device (T2), whether he or she wishes to be transported over at least part of said second determined route in progress.

5. A method according to claim 1, characterized in that in during step ii) during step ii) background information may be used, selected from (at least) a change in a second communication device's (T2) access network, a current time, detecting that a location having a known geographic position is being passed, presence detection at a determined geographic position, and data from a source of appointment data.

6. A method according to claim 5, characterized in that a person's (P) presence is detected by means of at least one technique chosen from a group comprising at least the acquisition of an identifier associated with a known geographic position, geographic positioning by means of a satellite navigation device, geographic positioning by triangulation within a wireless communication network, and geographic positioning by identifying an access point on a wireless communication network to which a second communication device (T2) is connected.

7. A method according to claim 1, characterized in that during step i) background information pertaining to said driver is used, selected from (at least) a change in the network used for access by a first communication device (T1), a current time, presence detection in the automobile vehicle (V), detecting that a location having a known geographic position is being passed, the automobile vehicle's (V) current determined geographic position, and data from a source of appointment data;
characterized in that in during step ii) during step ii) background information pertaining to said person may be used, selected from (at least) a change in a second communication device's (T2) access network, a current time, detecting that a location having a known geographic position is being passed, presence detection at a determined geographic position, and data from a source of appointment data; and
characterized in that selected weighting is assigned to the various types of background information depending on the level of confidence that is respectively granted to them, and each first or second route in progress is determined based on said background information and their respective weighting.

8. A method according to claim 1, characterized in that comprises for each driver (D) and each person (P) a phase of learning each of their usual first and second routes.

9. A system for automatically establishing contact between an automobile vehicle's (V) driver (D) and at least one person (P) who wishes to be transported, characterized in that it comprises i) analysis means (ANM) configured to determine, firstly, whether at least one driver (D) is disposed to transport at least one person (P) over at least part of a first usual known route in progress, based on background information pertaining to said driver, and secondly, if at least one person (P) wishes to be transported over at least part of a second usual known route in progress based on background information pertaining to said person, ii) calculation means (CLM) configured to determine a first route in progress which includes a significant part of a second route in progress, and iii) communication means (CNM) configured to establish contact between the corresponding driver (D) and person (P) respectively taking said first and second routes determined by said calculation means (CLM), via first (T1) and second (T2) communication devices, which they carry respectively.

10. A system according to claim 9, characterized in that said analysis means (ANM) are configured to determine whether a driver (D) has begun a first known route which he or she usually takes, based on background information pertaining to him or her, and if so, asking that driver (D), via his or her first communication device (T1), whether he or she is disposed to transport at least one person (P) over at least part of said first determined route in progress.

11. A system according to claim 9, characterized in that it comprises acquisition means (AQM) configured to acquire said background information pertaining to a driver (D) from (at least) a group comprising at least one change in the network used for access by a first communication device (T1), a current time, presence detection in the automobile vehicle (V), detecting that a location having a known geographic position is being passed, the automobile vehicle's (V) current determined geographic position, and data from a source of appointment data.

12. A system according to claim 9, characterized in that said analysis means (ANM) configured to determine whether a person (P) has begun a second known route that he or she usually takes based on background information pertaining to him or her, and if so, asking that person (P), via his or her second communication device (T2), whether he or she wishes to be transported over at least part of said second determined route in progress.

13. A system according to claim 9, characterized in that it comprises acquisition means (AQM) configured to acquire background information pertaining to a person (P) from a group comprising at least a change in a second communication device's (T2) access network, a current time, a usual time when a second route begins, a location having a known geographic position being passed, presence detection at a determined geographic position, and data from a source of appointment data.

14. A system according to claim 13, characterized in that said acquisition means (AQM) are configured to detect a person's (P) presence by means of at least one technique chosen from a group comprising at least the acquisition of an identifier associated with a known geographic position, geographic positioning by means of a satellite navigation device, geographic positioning by triangulation within a wireless communication network, and geographic positioning by identifying an access point on a wireless communication network to which a second communication device (T2) is connected.

15. A system according to claim 9, characterized in that it comprises acquisition means (AQM) configured to acquire said background information pertaining to a driver (D) from (at least) a group comprising at least one change in the network used for access by a first communication device (T1), a current time, presence detection in the automobile vehicle (V), detecting that a location having a known geographic position is being passed, the automobile vehicle's (V) current determined geographic position, and data from a source of appointment data;
characterized in that it comprises acquisition means (AQM) configured to acquire background information pertaining to a person (P) from a group comprising at least a change in a second communication device's (T2) access network, a current time, a usual time when a second route begins, a location having a known geographic position being passed, presence detection at a determined geographic position, and data from a source of appointment data; and
characterized in that said analysis means (ANM) are configured to determine each first or second route in progress based on said background information and weighting assigned to that information based on the levels of confidence respectively accorded to each piece of information.

16. A system according to claim 9, characterized in that it comprises learning means (LEM) configured to acquire said first and/or second usual routes from at least one driver (D) and/or at least one person (P).

17. A system according to claim 9, characterized in that it comprises learning means (LEM) configured to acquire said first and/or second usual routes from at least one driver (D) and/or at least one person (P); and
characterized in that it comprises a server (S) connected to at least one communication network and comprising said calculation means (CLM) and a part of at least said analysis means (ANM) and/or part of said learning means (LEM).
